(19) United States
(12) Patent Application Publication
(10) Pub. No.: US 2006/0242938 A1
(43) Pub. Date: Nov. 2, 2006

(54) Tine bar housing, tine bar, and pick-up unit for harvested agricultural material

(76) Inventors: Etienne Josset, Arc les Gray (FR); Jeremy Pourchet, Gilley (FR)

Correspondence Address: DEERE & COMPANY, ONE JOHN DEERE PLACE, MOLINE, IL, 61265, US

(21) Appl. No.: 11/408,828

(22) Filed: Apr. 20, 2006

(30) Foreign Application Priority Data
Apr. 29, 2005 (DE) 10 2005 020 464.3

(51) Int. Cl. A01D 34/13

(52) U.S. Cl. 56/289

(57) ABSTRACT

A tine bar of a pick-up unit for harvested agricultural material. The tine bar includes a tine bar housing having a housing cover with recesses for receiving tines. The recesses are adapted to permit end segments of the tines to extend outward from the housing. A plurality of tines that are attached to the tine bar housing, wherein each tine includes an end segment, and at least one end segment extends outward through one of the recesses in the housing cover.

### BACKGROUND OF THE INVENTION

1. Field of the Invention

The invention relates to a tine bar housing of a pick-up unit for harvested agricultural material and, furthermore, to a tine bar having such a tine bar housing.

2. Background of the Invention

Pick-up units for harvested agricultural material are employed on balers, trailers, harvesters, and forage harvesters in order to pick up material lying on the ground. They include a drum-type housing with slots through which steered or fixed tines extend for taking hold of the material. These tines are themselves arranged in tine bar housings that are subjected to heavy loads. These loads can result in deformations that make it necessary to replace the tine bar housing earlier than desired.

Accordingly, and in view of the above noted limitations of the prior art, a need exists for a more robust tine bar housing.

### SUMMARY

In overcoming the above noted drawbacks of the known technology, the present invention provides a more robust tine bar housing of a pick-up unit for harvested agricultural material. The housing has a housing cover with recesses that are suitable for permitting at least end segments of the tines to extend outward from the housing. The housing cover reinforces the tine bar housing such that the housing can better withstand torque and bending loads, while the mobility of the tines is not impeded. Further, depending on the particular design of the recesses, the tines are accessible for maintenance purposes or for exchange and/or removal and insertion.

In one aspect, the housing and the housing cover can be a single piece, having a tube or closed hollow profile. The recesses can be added to this tube or hollow profile by means of a laser cutting process. However, the housing and the housing cover can also be embodied as separate components that can be joined securely to one another by welding or other detachable attachment methods.

In another aspect, the housing cover can extend over the entire length of the tine bar housing, or alternatively, the cover can extend over only a portion of the length of the tine bar housing. With a tine bar housing of considerable length, it can be advantageous to have a cover that only covers segments of the tine bar housing. It is conceivable that such a tine bar housing cover would be arranged in end areas of the tine bar housing that are subjected to increased loads. Depending on the loads that occur, it can also be advantageous to provide such a housing cover only in one end area. The housing cover can be dimensioned such that it extends from one end area over approximately ⅔ of the length of the tine bar housing. However, a longer or shorter length is also conceivable depending on the particular application.

In still another aspect, the housing cover can also be embodied in a plurality of components that when assembled define the housing cover. Assembly of the housing cover is simple when the tine bar housing is substantially U-shaped. Moreover, such an embodiment is cost-effective.

In yet another aspect, the housing cover includes a bar positioned between each two adjacent recesses. This design provides particularly effective reinforcement, and is simple to manufacture.

A tine bar of a pick-up unit for harvested agricultural material can have one or a plurality of tines that are attached directly or indirectly to the tine bar housing and preferably have at least one end segment that extends outward through one of the recesses in the housing cover.

In still another aspect, the tines have a spiral segment that is positioned at least largely in an interior of the housing. The end segments of at least one tine extend outward from the spiral segment such that the tines can deflect, thereby improving reliability of the pick-up unit.

In order to counteract loads, the housing can have a rear reinforcement positioned in at least one of the rear areas of the housing. A pick-up unit for harvested agricultural material can have one or more such tine bars. Such a pick-up unit is employed on agricultural harvesting machines such as forage harvesters, combine harvesters, or balers.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a tine bar of an agricultural pick-up unit embodying the principles of the present invention;

FIG. 2 is an enlarged depiction of the right-hand end area of the tine bar seen in FIG. 1 with a housing cover and with tines arranged in the interior of the housing; and

FIG. 3 is an enlarged depiction of a left-hand end area of the tine bar housing of FIG. 1, as seen from below.

### DESCRIPTION OF THE EMBODIMENTS

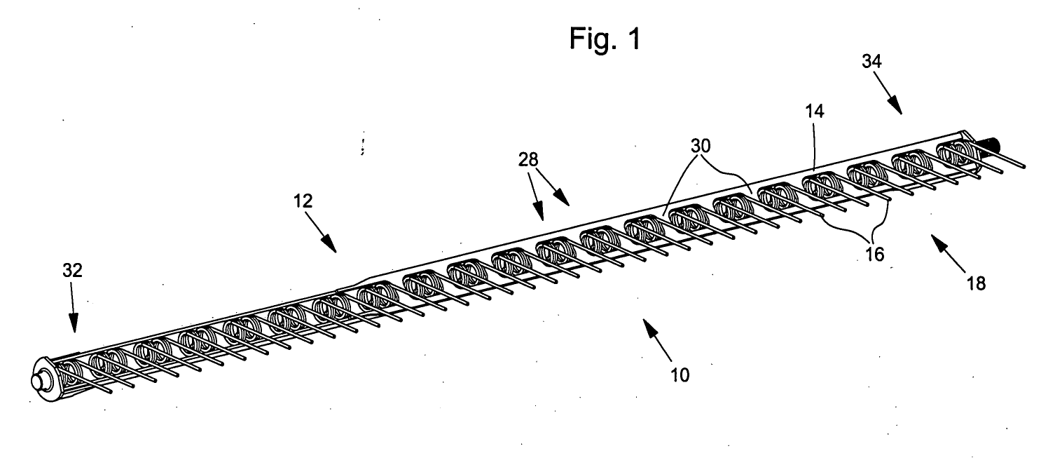

FIG. 1 illustrates a tine bar 10 of a pick-up unit for harvested material that embodies the principles of the present invention. Pick-up units generally of this variety are known for instance from DE-A-102 15 034. This type of pick-up unit has a plurality of tine bars 10, specifically four such tine bars 10 located about the pick-up unit and rotated thereby.

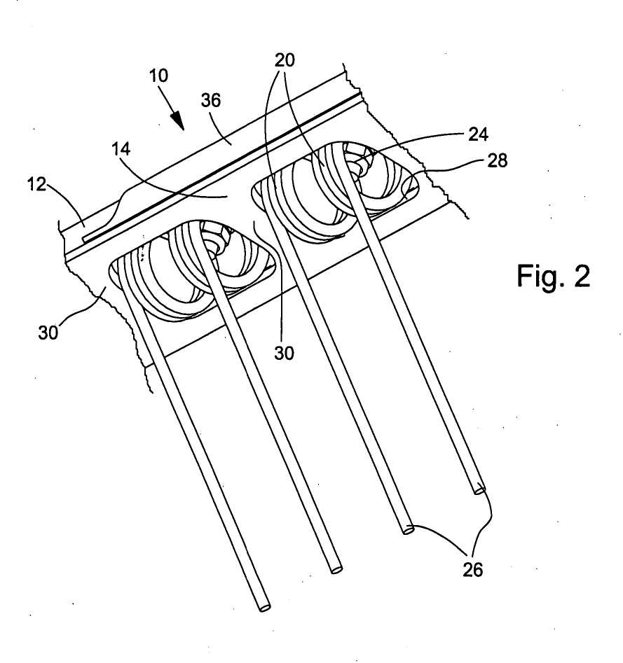

As readily seen in FIG. 2, the tine bar 10 has a housing 12, a housing cover 14, and a plurality of tines 16, a portion of which extend through openings 28 in the cover 14. The housing 12 has an open front 18 and is otherwise closed.

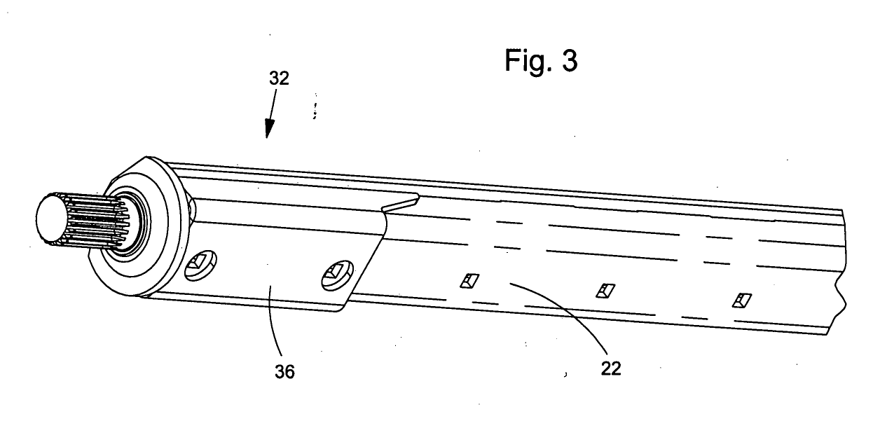

The tines 16 are produced from resilient material, such as steel rods, and include a biasing or spiral segment 20 (which may be a torsion or coil spring) that is received in the interior of the housing 12. The spiral segment 20 is joined to a back wall 22 (see FIG. 3) of the housing 12 using screw connections 24. End segments 26 extend outwardly through the openings 18 in the cover 14. In general the tines 22 are configured to pick up harvested material and convey it upward and to the rear when the pick-up unit moves across a field on which the harvested material generally lies in a swath.

The housing cover 14 is provided over the open front 18 of the housing 12. As shown, the housing cover 14 is securely joined, such as by welding, to the housing 12. However, the housing cover 14 may also be removably mounted onto the housing 12. Furthermore, the housing 12 and the housing cover 14 may also be integrally formed as a single part, having a tube like or closed profile.

As previously mentioned, the housing cover 14 has openings or recesses 28, which correspond to the number of tines 16 provided on the tine bar 10. The recesses 28 are adapted such that the end segments 26 can extend outward from the interior of the housing 12. Moreover, the recesses 28 are preferably dimensioned such that the tines 16 can be inserted into the interior of the housing 12 and/or can be removed therefrom and the screw connection 24 can be tightened and loosened, in order to facilitate removal and/or replacement of the tines 16. However, if provided with a removable housing cover 14, the recesses 28 may be dimensioned such that the tines 16 cannot travel completely through the recesses 28. For exchanging the tines 16 in that instance, the housing cover 14 first needs to be detached from the housing 12. As shown, the recesses 28 are inventively shaped such that the housing cover 14 forms bars 30 between the tines 16. The recesses 28 can be formed within the housing cover 1 by punching, cutting, laser cutting, or any other suitable method.

As seen in FIG. 1, the housing cover 14 extends from the end area 34 over approximately two-thirds of the length of the housing 12 and/or of the tine bar 10. The housing cover 14 can, however, extend over the entire housing 12. Alternatively, the housing cover 14 may extend over various segments of the housing 12. The tine bar 10, and thus the tine bar housing 12, each have end areas 32, 34. An additional reinforcement 36 is provided in both end areas 32, 34 on a rear side thereof, as seen in FIG. 3.

In accordance with the provisions of the patent statues, the present invention has been described in what is considered to represent its preferred embodiment. However, it should be noted that the invention can be practiced otherwise than as specifically illustrated and described.

1. A tine bar housing for a pick-up unit for harvested agricultural material, the tine bar housing comprising:
a housing body; and
a housing cover provided over at least a portion of the housing body, the housing cover including recesses for receiving tines, the recesses adapted to permit end segments of the tines to extend outward from the housing.

2. A tine bar housing in accordance with claim 1, wherein the housing cover and the housing body are of a one piece construction.

3. A tine bar housing in accordance with claim 1, wherein the housing body includes an open front portion and the housing cover extends across the open front of the housing body.

4. A tine bar housing in accordance with claim 1, wherein the housing cover is comprised of more than section.

5. A tine bar housing in accordance with claim 1, wherein the housing body is substantially U-shaped.

6. A tine bar housing in accordance with claim 1, wherein the housing cover includes a bar positioned between two adjacent recesses.

7. A tine bar of a pick-up unit for harvested agricultural material, the tine bar comprising:
a tine bar housing having a housing cover, portions of the housing cover defining a plurality of openings therein for receiving tines, the opening being configured to permit end segments of the tines to extend outward from the tine bar housing; and
a plurality of tines attached to the tine bar housing, wherein each tine including an end segment extending outward from the tine bar housing, at least one end segment extending outward from the tine bar housing through one of the openings in the housing cover.

8. A tine bar in accordance with claim 7, wherein the plurality of tines are formed with a biasing segment and at least half of the tines having their biasing segments positioned within an interior of the tine bar housing closed by the housing cover, at least one end segment extending from each biasing segment.

9. A tine bar in accordance with claim 7, further comprising a rear housing reinforcement positioned over a rear area of the tine bar housing.

10. A tine bar in accordance with claim 7, wherein the tine bar housing includes a housing body defining an open front and the housing cover extends over at least portion of the open front.

11. A tine bar in accordance with claim 7, wherein the housing cover includes a bar positioned between adjacent openings in the housing cover.

12. A tine bar in accordance with claim 7, wherein the tines with end segments extending through the openings are removable from the tine bar through the openings.

13. A tine bar in accordance with claim 7, wherein the tine bar housing and housing cover are one piece.

14. A tine bar in accordance with claim 7, wherein the housing cover extends over less than the full length of the tine bar housing.

15. A tine bar in accordance with claim 7, wherein the housing cover is provided on at least one end of the tine bar housing.
